(19) United States
(12) Patent Application Publication
(10) Pub. No.: US 2012/0075158 A1
(43) Pub. Date: Mar. 29, 2012

(54) ANTENNA MODULE

(75) Inventor: Kazunari KAWAHATA, Kyoto-fu (JP)

(73) Assignee: MURATA MANUFACTURING CO., LTD., Kyoto-fu (JP)

(21) Appl. No.: 13/310,197

(22) Filed: Dec. 2, 2011

Related U.S. Application Data
(63) Continuation of application No. PCT/JP2010/056695, filed on Apr. 14, 2010.

(30) Foreign Application Priority Data
Jun. 3, 2009 (JP) 2009-134228

(51) Int. Cl. H01Q 1/50; H01Q 21/28

(52) U.S. Cl. 343/858; 343/893

(57) ABSTRACT

An antenna module is provided and includes two feeding parts and having different frequencies of feeding on a circuit board. A first feeding radiation electrode is connected to the feeding part on a lower frequency side and performs an antenna operation. A second feeding radiation electrode is connected to the feeding part on a higher frequency side and performs an antenna operation. The first and second feeding radiation electrodes electrically connected, and the second feeding radiation electrode is smaller than and on the first feeding radiation electrode with an insulating part therebetween. The first feeding radiation electrode is configured to serve as an electrode that also performs an antenna operation of the second feeding radiation electrode, in such a manner that the second feeding radiation electrode performs an antenna operation in which the second feeding radiation electrode and the first feeding radiation electrode are electrically coupled to each other.

### CROSS REFERENCE TO RELATED APPLICATIONS

The present application is a continuation of International Application No. PCT/JP2010/056695 filed Apr. 14, 2010, which claims priority to Japanese Patent Application No. 2009-134228 filed Jun. 3, 2009, the entire contents of each of these applications being incorporated herein by reference in their entirety.

### TECHNICAL FIELD

The present invention relates to small-sized antenna modules that can be applied to cellular phones, small-sized PCs, or the like.

### BACKGROUND

In recent years, multi-band antenna modules have been used in wireless devices (e.g., cellular phones), and performance improvement in such modules has been desired. FIG. 6 illustrates a multi-band antenna structure of an example of related art applied to a cellular phone. See, NTT Docomo Technical Journal Vol. 14, No. 2 (Non-Patent Document 1). In this antenna structure, an antenna element 41 with a band of 800 MHz and an antenna element 42 with a band of 1.7/2 GHz are individually formed. Radiation electrodes forming the antenna elements 41 and 42 are connected to a switch 47 via feeding points 43 and 44 and matching circuits 45 and 46, respectively, provided on the side of a casing 48, which is on the side of keys. FIG. 6 illustrates an example of an antenna structure provided in a foldable cellular phone. In the drawing, reference numeral 49 denotes a casing on the side of a liquid crystal display. In this structure, the antenna elements 41 and 42 each perform a radiating operation including the casings 48 and 49.

FIG. 7 illustrates a multi-band antenna structure of another example of related art. See, Japanese Unexamined Patent Application Publication No. 2006-81181 (Patent Document 1). In this antenna structure, a main-antenna radiation electrode 51 and a chip antenna (chip/loop antenna) 52 having a different function are each connected to a switch 53. The switch 53 is connected to a feeding point (not illustrated) via a matching circuit. That is, this antenna structure has a configuration in which the main-antenna radiation electrode 51 and the chip antenna 52 are selectively connected to the single feeding point via the switch 53.

### SUMMARY

In an embodiment, an antenna module includes a circuit board including two feeding parts having different frequencies of feeding respectively on a first frequency side and a second frequency side higher than the first frequency side. A first feeding radiation electrode is connected to the feeding part on the lower frequency side and performs an antenna operation. A second feeding radiation electrode is connected to the feeding part on the higher frequency side and performs an antenna operation. The second feeding radiation electrode is smaller than the first feeding radiation electrode, is on the first feeding radiation electrode with an insulating part therebetween, and has an integrated structure the first feeding radiation electrode. Unbalanced feeding lines including a hot line and a ground line are connected to each of the first and second feeding radiation electrodes. The hot line connected to each of the first and second feeding radiation electrodes is connected to a corresponding feeding part, and the ground line connected to the second feeding radiation electrode is connected, via the first feeding radiation electrode, to a ground provided on a side of the circuit board, in such a manner that the second feeding radiation electrode performs an antenna operation in which the second feeding radiation electrode and the first feeding radiation electrode are electrically coupled to each other.

In a more specific embodiment, the antenna module may include a circuit having a frequency characteristic exhibiting a high impedance at an exciting frequency of the second feeding radiation electrode connected to the ground line connected to the first feeding radiation electrode, and a circuit having a frequency characteristic exhibiting a high impedance at an exciting frequency of the first feeding radiation electrode connected to the ground line connected to the second feeding radiation electrode.

In another more specific embodiment, the ground line connected to the second feeding radiation electrode may be on the same plane as the first feeding radiation electrode, and the hot line connected to the second feeding radiation electrode may be near and forms a coplanar structure with the ground line.

In another more specific embodiment, the ground line connected to the second feeding radiation electrode may be formed by employing the first feeding radiation electrode, and the hot line may be formed at a rear side of the ground line to provide a microstrip line structure or a triplate structure.

In yet another more specific embodiment, the antenna module may include a chip antenna including the second feeding radiation electrode on the first feeding radiation electrode, where one end of the second feeding radiation electrode is connected in a high-frequency manner to the first feeding radiation electrode, such that the chip antenna serves as a chip antenna of a λ/4-resonant type.

In another more specific embodiment, the second feeding radiation electrode may be formed of a helical electrode having a helical structure, and the chip antenna including the second feeding radiation electrode may be provided on the first feeding radiation electrode.

In another more specific embodiment, at least one of the first and second feeding radiation electrodes is connected to a frequency-variable circuit, and connection lines for controlling the frequency-variable circuit are near the unbalanced feeding lines.

In another more specific embodiment, a matching circuit may be formed for at least the second feeding radiation electrode, out of the second feeding radiation electrode and the first feeding radiation electrode, and the matching circuit for the second feeding radiation electrode may be on the first feeding radiation electrode.

In still another more specific embodiment, the first feeding radiation electrode or the second feeding radiation electrode may be provided in a plural form.

### BRIEF DESCRIPTION OF DRAWINGS

FIG. 1a is a schematic explanatory diagram for explaining an antenna module according to a first exemplary embodiment.

FIG. 1b is a schematic block explanatory diagram for explaining the antenna module according to the first exemplary embodiment.

FIG. 1c is a schematic block explanatory diagram for explaining the antenna module according to the first exemplary embodiment.

FIG. 2a is an explanatory diagram schematically illustrating, by using a cross-sectional view and a plan view, an example of a structure of unbalanced feeding lines.

FIG. 2b is an explanatory diagram schematically illustrating, by using a cross-sectional view and a plan view, another example of a structure of the unbalanced feeding lines.

FIG. 2c is an explanatory diagram schematically illustrating, by using a cross-sectional view and a rear view, another example of a structure of the unbalanced feeding lines.

FIG. 3a is a schematic explanatory diagram for explaining an antenna module according to a second exemplary embodiment.

FIG. 3b is a schematic block explanatory diagram for explaining the antenna module according to the second exemplary embodiment.

FIG. 4 is an explanatory diagram illustrating an example of a chip antenna.

FIG. 5 is an explanatory diagram illustrating an example of a configuration of formation of unbalanced feeding lines and control lines.

FIG. 6 is an explanatory diagram illustrating a structure of a multi-band antenna having a foldable structure of an example of related art.

FIG. 7 is an explanatory diagram illustrating the structure of a multi-band antenna of another example of related art.

### DETAILED DESCRIPTION

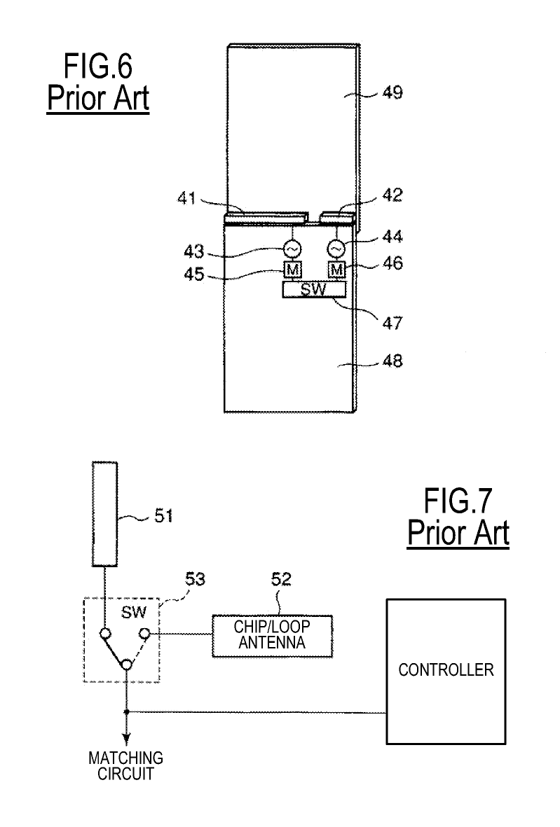

The inventor realized that in an antenna element configuration such as shown in FIG. 6, in which each of the antenna element 41 and the antenna element 42 is smaller than ¼ the wavelength of a free space where the antenna elements 41 and 42 each perform a radiating operation including the casings 48 and 49, problems can occur. More specifically, because the casing 48 is determined in advance to have a length in accordance with the design of a cellular phone, there is a low degree of freedom in designing of installation, dimensions etc. of the antenna elements 41 and 42. Furthermore, there is a problem in that it is difficult for radiation of the antenna element 41 and radiation of the antenna element 42 to have individually optimal characteristics. Moreover, since the antenna element 41 with a band of 800 MHz and the antenna element 42 with a band of 1.7/2 GHz are individually formed and arranged in a limited space, the size of the antenna element 41 is reduced. This causes a problem of limitation in increasing the bandwidth of 800 MHz band.

In the antenna structure illustrated in FIG. 7, the operation of the main-antenna radiation electrode 51 and the operation of the chip antenna 52 are selectively performed by the switch 53. The inventor realized this causes a problem in which the main-antenna radiation electrode 51 and the chip antenna 52 cannot be used at the same time. Furthermore, in this antenna structure, the chip antenna 52 serves as an unbalanced feed chip antenna. Such an unbalanced feed chip antenna is often designed to be small by positively employing radiation from a casing, and the characteristics of such an unbalanced feed chip antenna depend on the position where the antenna is installed and the size of the casing in which the antenna is installed. Therefore, there is a problem in that it is difficult to design the chip antenna 52 optimally.

Hereinafter, exemplary embodiments of the present disclosure that address the above problems will now be explained with reference to the drawings.

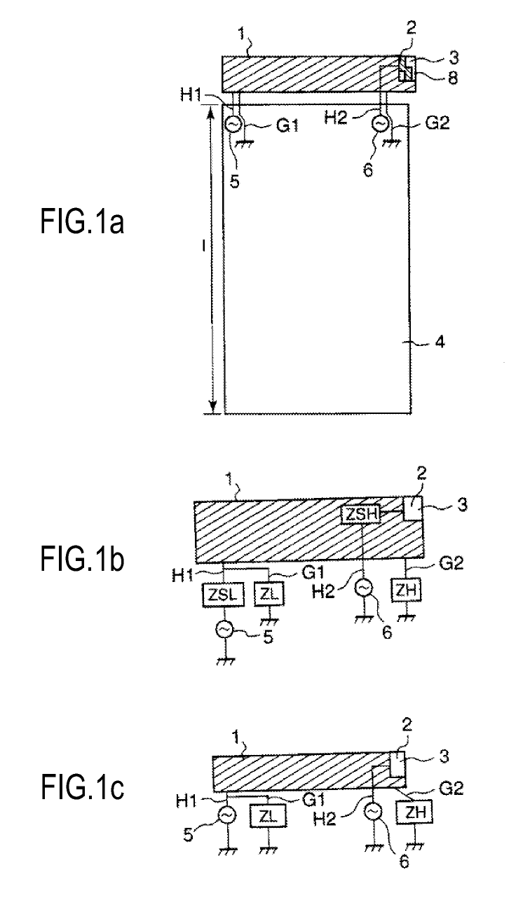

FIG. 1a illustrates a schematic plan view of a structure of an antenna module according to a first exemplary embodiment. The antenna module according to the first embodiment is provided in the casing of a cellular phone. As illustrated in the drawing, two feeding parts 5 and 6 having different frequencies of feeding are formed on a circuit board 4 of the casing. A first feeding radiation electrode 1 is connected to the feeding part 5, which is on a lower frequency side of the two feeding parts 5 and 6, and performs an antenna operation. A second feeding radiation electrode 2 is connected to the feeding part 6, which is on a higher frequency side of the two feeding parts 5 and 6, and performs an antenna operation. For example, the frequency of feeding on the lower frequency side can be set to a band of 800 MHz, and the frequency of feeding on the higher frequency side can be set to a band of 1.7/2 GHz.

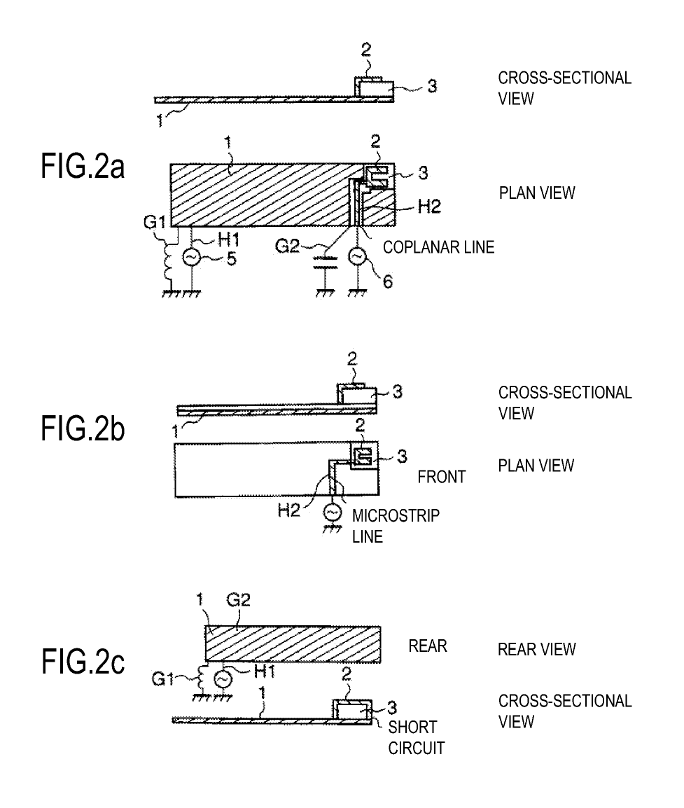

The second feeding radiation electrode 2 is formed so as to be smaller than the first feeding radiation electrode 1. The first feeding radiation electrode 1 and the second feeding radiation electrode 2 are formed as an integrated structure. A chip antenna 3 including the second feeding radiation electrode 2 is provided on the first feeding radiation electrode 1. The chip antenna 3 is formed by arranging the second feeding radiation electrode 2 on an insulating substrate 8 (or sheet). Accordingly, the second feeding radiation electrode 2 is configured to be provided on the first feeding radiation electrode 1 with the insulating part therebetween. The shape of the second feeding radiation electrode 2 is not necessarily limited to the depicted shape and may be appropriately set. The second feeding radiation electrode 2 may have a shape, for example, illustrated in FIG. 1a, or may have a shape, for example, illustrated in any of FIGS. 2a to 2c. In FIGS. 1b and 1c, the shape of the second feeding radiation electrode 2 is illustrated in an abbreviated manner.

For example, in FIG. 2c, one end of the second feeding radiation electrode 2 is electrically connected in a high-frequency manner to the first feeding radiation electrode 1. This structure causes the chip antenna 3 to serve as a chip antenna of a λg/4-resonant type (λg represents a case of wavelength shortening) at high frequencies. That is, the total electrical length obtained by adding the electrical length of the first feeding radiation electrode 1 (here, the length in the longitudinal direction of the first feeding radiation electrode 1) and the electrical length of the second feeding radiation electrode 2 is set to λ/2 the electrical length at the exciting frequency of the second feeding radiation electrode 2, so that radiation is performed. The antenna operation on the lower frequency side by the first feeding radiation electrode 1 is independently configured so as not to affect the second feeding radiation electrode 2.

The total length obtained by adding the electrical length of the first feeding radiation electrode 1 and the length l in the longitudinal direction of the circuit board 4 (see FIG. 1) is set to be equivalent to λ₀/2 the electrical length at the exciting frequency of the first feeding radiation electrode 1. The first feeding radiation electrode 1 performs an antenna operation on a lower frequency side in which the first feeding radiation electrode 1 and the circuit board 4 each perform a radiating operation.

As illustrated in FIG. 1a, hot lines H1 and H2 and ground lines G1 and G2 are connected to the first feeding radiation electrode 1 and the second feeding radiation electrode 2, respectively. The hot line H1 and the ground line G1, which are connected to the first feeding radiation electrode 1, form unbalanced feeding lines. Similarly, the hot line H2 and the ground line G2, which are connected to the second feeding radiation electrode 2, form unbalanced feeding lines. The hot lines H1 and H2 are connected to the corresponding feeding parts 5 and 6.

The ground line G1 is connected to the ground (ground electrode) provided on the side of the circuit board 4 (here, on the front side). Furthermore, the ground line G2 for the second feeding radiation electrode 2 is connected, via the first feeding radiation electrode 1, to the ground provided on the side of the circuit board 4, so that the second feeding radiation electrode 2 can perform an antenna operation in which the second feeding radiation electrode 2 and the first feeding radiation electrode 1 are electrically coupled to each other. In the present disclosure, in a case where the ground of the casing is connected to the ground of the circuit board, the ground provided on the side of the circuit board means all the grounds connected to the ground of the circuit board, for example, including the ground of the casing.

As illustrated in the schematic block explanatory diagram of FIG. 1b, a series matching circuit for lower frequency ZSL and circuit for connecting ground to ground line for lower frequency ZL are arranged for the unbalanced feeding lines (i.e., the hot line H1 and the ground line G1) connected to the first feeding radiation electrode 1. The circuit ZSL is connected to the hot line H1, and the circuit ZL is connected to the ground line G1. The circuits ZSL and ZL have a frequency characteristic exhibiting a high impedance at the exciting frequency of the second feeding radiation electrode 2 and achieve impedance matching at the exciting frequency of the first feeding radiation electrode 1. A series matching circuit for higher frequency ZSH and circuit for connecting ground to ground line for higher frequency ZH are arranged for the unbalanced feeding lines (i.e., the hot line H2 and the ground line G2) connected to the second feeding radiation electrode 2. The circuit ZSH is connected to the hot line H2 and the circuit ZH is connected to the ground line G2. The circuit ZSH is formed on the first feeding radiation electrode 1. The circuits ZSH and ZH have a frequency characteristic exhibiting a high impedance at the exciting frequency of the first feeding radiation electrode 1 and achieve impedance matching at the exciting frequency of the second feeding radiation electrode 2. As illustrated in the schematic block explanatory diagram of FIG. 1c, the circuits ZSL and ZSH provided in the embodiment shown in FIG. 1b may be provided in other embodiments.

Although the way of forming the unbalanced feeding lines connected to the second feeding radiation electrode 2 is not particularly limited, the unbalanced feeding lines can be configured, for example, as illustrated in FIG. 2a. This configuration has a coplanar structure in which, out of the ground line G2 and the hot line H2 connected to the second feeding radiation electrode 2, the ground line G2 is formed by employing the first feeding radiation electrode 1 and the hot line H2 is formed near the ground line G2. In the example illustrated in FIG. 2b, out of the ground line G2 and the hot line H2 connected to the second feeding radiation electrode 2, the ground line G2 is formed by employing the first feeding radiation electrode 1. Here, the first feeding radiation electrode 1 is formed on a rear side, which is opposite to the side on which the second feeding radiation electrode 2 is formed. In addition, a configuration including a microstrip line structure or a triplate structure can be provided by forming the hot line H2 on a rear side of the ground line G2 (that is, a front side).

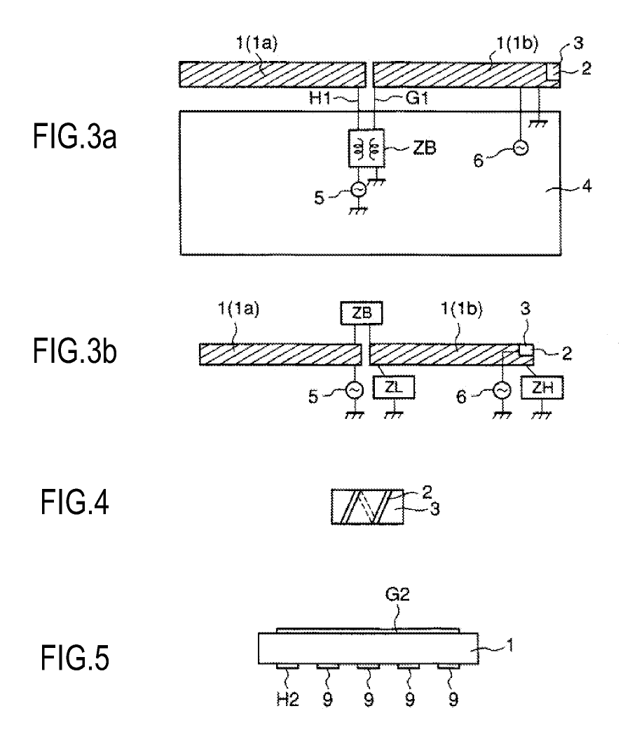

FIG. 3a illustrates, by using a schematic plan view, the configuration of an antenna module according to a second exemplary embodiment. In the explanation of the second exemplary embodiment, parts of the same names as those in the first embodiment are referred to with the same reference numerals and signs and redundant explanations of those parts will not be provided or will be simplified. A feature of the second exemplary embodiment, which is different from those in the first exemplary embodiment, is that the first feeding radiation electrode 1 is formed by two electrodes 1a and 1b that are arranged with a space therebetween.

As illustrated in a schematic block explanatory diagram of FIG. 3b, the first feeding radiation electrode 1a and the first feeding radiation electrode 1b are electrically connected to each other with a balloon circuit (a balance-unbalance conversion circuit; phase inversion circuit) ZB therebetween. On the first feeding radiation electrode 1b, the second feeding radiation electrode 2 and the chip antenna 3 including the second feeding radiation electrode 2 are provided. In FIGS. 3a and 3b, the shape of the second feeding radiation electrode 2 is illustrated in an abbreviated manner.

The antenna module according to the second exemplary embodiment can be provided inside a small-sized PC. In the first exemplary embodiment, a configuration in which the first feeding radiation electrode 1 resonates in conjunction with the circuit board 4 is provided. In contrast, in the second exemplary embodiment, a configuration in which the first feeding radiation electrode 1a and the first feeding radiation electrode 1b resonate in conjunction with each other is provided. Therefore, in the second exemplary embodiment, the characteristic of the first feeding radiation electrode 1 is determined in accordance with the total length of the electrical length of the first feeding radiation electrode 1a and the electrical length of the first feeding radiation electrode 1b, etc.

The present disclosure is not limited to the embodiments described above, and various other embodiments may be employed. For example, a pattern for forming the second feeding radiation electrode 2 to be formed in the chip antenna 3 is not particularly limited and can be set appropriately. For example, as illustrated in FIG. 4, the second feeding radiation electrode 2 may be formed of a helical electrode having a helical structure, and the chip antenna 3 including the second feeding radiation electrode 2 may be formed on the first feeding radiation electrode 1.

In addition, at least one of the first and second feeding radiation electrodes 1 and 2 may be connected to a frequency-variable circuit, and, for example, as illustrated in FIG. 5, connection lines 9 for controlling the frequency-variable circuit may be formed near unbalanced feeding lines.

Furthermore, although the chip antenna 3 including the second feeding radiation electrode 2 is provided on the first feeding radiation electrode 1 in each of the above embodiments, the second feeding radiation electrode 2 is not necessarily formed in the form of the chip antenna 3. That is, the second feeding radiation electrode 2 is only needed to be formed on the first feeding radiation electrode 1 with an insulating part therebetween and be electrically connected to the first feeding radiation electrode 1.

Furthermore, the details of the shape, size, and so on of the first feeding radiation electrode 1 and the second feeding radiation electrode 2 are not particularly limited and can be set appropriately, for example, in accordance with the size and so on of a cellular phone or a small-sized PC.

Furthermore, regarding the antenna module according to the first exemplary embodiment, implementation in the casing has been explained by taking an example of a wireless device having a foldable structure. However, a wireless device in which the antenna module is to be implemented does not necessarily have a foldable structure and can be applied to a general straight terminal or a slide structure. Moreover, the position at which the antenna module is to be implemented is not limited.

The antenna module according to the present disclosure is capable of achieving the compatibility of radiation characteristics of two feeding radiation electrodes having different exciting frequencies, and such antennas can be used at the same time according to need. Thus, the antenna module can be used as an antenna module for a wireless device, such as a cellular phone or a small-sized PC.

In embodiments according to the present disclosure, an antenna module is provided with first and second feeding radiation electrodes, where each of these electrodes is connected to one of two feeding parts having different frequencies of feeding and performing an antenna operation. The ground for the second feeding radiation electrode that performs an antenna operation on a higher frequency side is connected, doubling as the first feeding radiation electrode. The first feeding radiation electrode is configured to serve as one electrode that also performs an unbalanced antenna operation of the second feeding radiation electrode so that the first and second feeding radiation electrodes can perform, in conjunction with each other, an asymmetric dipole antenna operation. Therefore, the characteristics of the second feeding radiation electrode are not likely to be susceptible to the size of a circuit board side (including a casing connected to the circuit board).

Consequently, in embodiments consistent with the present disclosure, it is possible to design the first and second feeding radiation electrodes optimally, and excellent radiation characteristics of the first and second feeding radiation electrodes can be achieved. In addition, an antenna operation is not performed by selectively connecting, using a switch, the first and second feeding radiation electrodes to a single feeding part. Thus, since isolation of individual frequencies can be readily controlled, the first feeding radiation electrode and the second feeding radiation electrode can be used at the same time.

In addition, the small-sized second feeding radiation electrode is provided on the first feeding radiation electrode with the insulating part therebetween. Thus, unlike a case where the first feeding radiation electrode and the second feeding radiation electrode are independently provided on the circuit board, there is no need to require a space where the second feeding radiation electrode is to be arranged, separately from a space where the first feeding radiation electrode is to be arranged. Therefore, even in a limited antenna space in a cellular phone or the like, a sufficient space can be provided for the arrangement of the first and second feeding radiation electrodes, and the electrical length of first and second feeding radiation electrodes can be set to be sufficiently long.

Furthermore, a hot line and a ground line are connected to each of the first feeding radiation electrode and the second feeding radiation electrode. The hot line is connected to a corresponding feeding part, and the ground line is connected to the ground provided on a side of the circuit board. Since a circuit having a frequency characteristic exhibiting a high impedance at the exciting frequency of an opposite feeding radiation electrode is arranged for each ground line, the radiation characteristics of the first and second feeding radiation electrodes can be adjusted to be optimal in an independent manner. Thus, an antenna module can be designed adequately. That is, in the present disclosure, the first feeding radiation electrode is not deteriorated by the second feeding radiation electrode, and the second feeding radiation electrode also achieves an optimal resonant characteristic.

According to an above-described embodiment of the present disclosure, out of the ground line and the hot line connected to the second feeding radiation electrode, the ground line is formed by employing the first feeding radiation electrode, and the hot line is formed near the ground line, so that a coplanar structure is provided. With this structure, the thickness of an area where the ground line and the hot line are formed can be reduced.

In addition, according to another preferable embodiment, out of the ground line and the hot line connected to the second feeding radiation electrode, the ground line is formed by employing the first feeding radiation electrode, and the hot line is formed at a rear side of the ground line. Accordingly, a microstrip line structure or a triplate structure can be provided. Thus, unnecessary radiation from the unbalanced feeding lines of the second feeding radiation electrode can be suppressed.

Furthermore, according to another embodiment, a chip antenna including the second feeding radiation electrode is provided on the first feeding radiation electrode, and one end of the second feeding radiation electrode is connected in a high-frequency manner to the first feeding radiation electrode, so that the chip antenna serves as a chip antenna of a λ/4-resonant type. Thus, since the current distribution of the first feeding radiation electrode can be controlled by the second feeding radiation electrode, the first feeding radiation electrode is unlikely to be susceptible to metal such as the ground on a side of the circuit board (including metal on a casing side in which the circuit board is arranged).

Furthermore, according to another embodiment, the second feeding radiation electrode can be formed of a helical electrode having a helical structure, and the chip antenna including the second feeding radiation electrode can be provided on the first feeding radiation electrode. Thus, the electrical length of the second feeding radiation electrode can be easily formed to be loner, and the bandwidth of the antenna can be increased.

In the present disclosure, regarding the second feeding radiation electrode, not limited to the chip antenna, a small-sized antenna having the same function can be integrated with the first feeding radiation electrode.

In addition, according to another embodiment, at least one of the first and second feeding radiation electrodes can be connected to a frequency-variable circuit, and connection lines for controlling the frequency-variable circuit can be formed near the unbalanced feeding lines. Thus, the density of integration of the antenna module can be increased.

Furthermore, according to another embodiment, a matching circuit can be formed for at least the second feeding radiation electrode, out of the second feeding radiation electrode and the first feeding radiation electrode, and the matching circuit for the second feeding radiation electrode can be formed on the first feeding radiation electrode. Thus, a high-frequency current that flows to the first feeding radiation electrode and serves as an image current of the second feeding radiation electrode can be easily controlled, and matching can be easily achieved.

Furthermore, according to another embodiment, the first feeding radiation electrode or the second feeding radiation electrode can be provided in a plural form. Thus, in a case where a plurality of bandwidths are further required in a portable device for which multi-band processing is required, the size of the antenna module can be reduced.

That which is claimed is:

1. An antenna module comprising:
a circuit board including two feeding parts having different frequencies of feeding on a first frequency side and a second frequency side higher than the first frequency side, respectively;
a first feeding radiation electrode connected to the feeding part on the lower frequency side and performing an antenna operation;
a second feeding radiation electrode connected to the feeding part on a higher frequency side and performing an antenna operation, said second feeding radiation electrode is smaller than the first feeding radiation electrode, formed on the first feeding radiation electrode with an insulating part therebetween, and has an integrated structure with the first feeding radiation electrode; and
unbalanced feeding lines including a hot line and a ground line connected to each of the first and second feeding radiation electrodes, wherein
each hot line is connected to a corresponding one of the feeding parts, and the ground line connected to the second feeding radiation electrode is connected, via the first feeding radiation electrode, to a ground provided on a side of the circuit board, in such a manner that the second feeding radiation electrode performs an antenna operation in which the second feeding radiation electrode and the first feeding radiation electrode are electrically coupled to each other.

2. The antenna module according to claim 1, further comprising:
a circuit having a frequency characteristic exhibiting a high impedance at an exciting frequency of the second feeding radiation electrode connected to the ground line connected to the first feeding radiation electrode; and
a circuit having a frequency characteristic exhibiting a high impedance at an exciting frequency of the first feeding radiation electrode connected to the ground line connected to the second feeding radiation electrode.

3. The antenna module according to claim 2, wherein, the ground line connected to the second feeding radiation electrode is on the same plane as the first feeding radiation electrode, and the hot line connected to the second feeding radiation electrode is near and forms a coplanar structure with the ground line.

4. The antenna module according to claim 2, wherein, the ground line connected to the second feeding radiation electrode is formed by employing the first feeding radiation electrode, and the hot line is formed at a rear side of the ground line to provide a microstrip line structure or a triplate structure.

5. The antenna module according to claim 1, further comprising:
a chip antenna including the second feeding radiation electrode on the first feeding radiation electrode, wherein
one end of the second feeding radiation electrode is connected in a high-frequency manner to the first feeding radiation electrode, such that the chip antenna serves as a chip antenna of a λ/4-resonant type.

6. The antenna module according to claim 2, further comprising:
a chip antenna including the second feeding radiation electrode on the first feeding radiation electrode, wherein
one end of the second feeding radiation electrode is connected in a high-frequency manner to the first feeding radiation electrode, such that the chip antenna serves as a chip antenna of a λ/4-resonant type.

7. The antenna module according to claim 3, further comprising:
a chip antenna including the second feeding radiation electrode on the first feeding radiation electrode, wherein
one end of the second feeding radiation electrode is connected in a high-frequency manner to the first feeding radiation electrode, such that the chip antenna serves as a chip antenna of a λ/4-resonant type.

8. The antenna module according to claim 4, further comprising:
a chip antenna including the second feeding radiation electrode on the first feeding radiation electrode, wherein
one end of the second feeding radiation electrode is connected in a high-frequency manner to the first feeding radiation electrode, such that the chip antenna serves as a chip antenna of a λ/4-resonant type.

9. The antenna module according to claim 5, wherein the second feeding radiation electrode is formed of a helical electrode having a helical structure, and the chip antenna including the second feeding radiation electrode is provided on the first feeding radiation electrode.

10. The antenna module according to claim 6, wherein the second feeding radiation electrode is formed of a helical electrode having a helical structure, and the chip antenna including the second feeding radiation electrode is provided on the first feeding radiation electrode.

11. The antenna module according to claim 7, wherein the second feeding radiation electrode is formed of a helical electrode having a helical structure, and the chip antenna including the second feeding radiation electrode is provided on the first feeding radiation electrode.

12. The antenna module according to claim 8, wherein the second feeding radiation electrode is formed of a helical electrode having a helical structure, and the chip antenna including the second feeding radiation electrode is provided on the first feeding radiation electrode.

13. The antenna module according to claim 2, wherein at least one of the first and second feeding radiation electrodes is connected to a frequency-variable circuit, and connection lines for controlling the frequency-variable circuit are near the unbalanced feeding lines.

14. The antenna module according to claim 3, wherein at least one of the first and second feeding radiation electrodes is connected to a frequency-variable circuit, and connection lines for controlling the frequency-variable circuit are near the unbalanced feeding lines.

15. The antenna module according to claim 4, wherein at least one of the first and second feeding radiation electrodes is connected to a frequency-variable circuit, and connection lines for controlling the frequency-variable circuit are near the unbalanced feeding lines.

16. The antenna module according to claim 1, wherein a matching circuit is formed for at least the second feeding radiation electrode, out of the second feeding radiation electrode and the first feeding radiation electrode, and the matching circuit for the second feeding radiation electrode is on the first feeding radiation electrode.

17. The antenna module according to claim 2, wherein a matching circuit is formed for at least the second feeding radiation electrode, out of the second feeding radiation electrode and the first feeding radiation electrode, and the matching circuit for the second feeding radiation electrode is on the first feeding radiation electrode.

18. The antenna module according to claim 3, wherein a matching circuit is formed for at least the second feeding radiation electrode, out of the second feeding radiation electrode and the first feeding radiation electrode, and the matching circuit for the second feeding radiation electrode is on the first feeding radiation electrode.

19. The antenna module according to claim 4, wherein a matching circuit is formed for at least the second feeding radiation electrode, out of the second feeding radiation electrode and the first feeding radiation electrode, and the matching circuit for the second feeding radiation electrode is on the first feeding radiation electrode.

20. The antenna module according to claim 1, wherein the first feeding radiation electrode or the second feeding radiation electrode is provided in a plural form.
